(19) United States
(12) Patent Application Publication
(10) Pub. No.: US 2026/0141295 A1
(43) Pub. Date: May 21, 2026

(54) SELECTIVE MACHINE LEARNING MODEL EXECUTION FOR REDUCED RESOURCE USAGE

(71) Applicant: QUALCOMM Incorporated, San Diego, CA (US)

(72) Inventor: Deepak BABU SAM, Pathanamthitta (IN)

(21) Appl. No.: 19/118,507

(22) PCT Filed: Sep. 29, 2023
(86) PCT No.: PCT/US2023/075585

§ 371 Date: Apr. 4, 2025

(30) Foreign Application Priority Data
Nov. 15, 2022 (IN) 202241065481

(51) Int. Cl. G06N 20/00

(52) U.S. Cl. CPC G06N 20/00

(57) ABSTRACT

Certain aspects of the present disclosure provide techniques and apparatus for improved machine learning. A machine learning model is executed to generate a model output based on first input data. A model simulator is executed to generate a simulator output based on the generated model output. An error between the generated simulator output and the generated model output is determined, and whether to execute the machine learning model for second input data is selected based on the error.

### CROSS-REFERENCE TO RELATED APPLICATIONS

This application claims the benefit of and priority to Indian Provisional Patent Application No. 202241065481, filed Nov. 15, 2022, the entire contents of which are incorporated herein by reference.

### INTRODUCTION

Aspects of the present disclosure relate to machine learning.

Various machine learning architectures have been used to provide solutions for a wide variety of computational problems. An assortment of machine learning model architectures exist, such as artificial neural networks (which may include convolutional neural networks (CNNs), recurrent neural networks (RNNs), deep neural networks, generative adversarial networks (GANs), and the like), random forest models, and the like. As can be seen in a wide variety of deployments, machine learning can be used to solve complex problems with high accuracy.

However, a common difficulty for machine learning solutions is the computational complexity of the models. Though training machine learning models is frequently more computationally expensive than inferencing using trained models, the inferencing process often still depends on substantial computing resources. For example, generating machine learning model output generally takes substantial memory and/or compute time, and can further consume substantial power (which is particularly problematic for battery-powered devices).

### BRIEF SUMMARY

Certain aspects provide a method comprising: executing a machine learning model to generate a model output based on first input data; executing a model simulator to generate a simulator output based on the generated model output; determining an error between the generated simulator output and the generated model output; and selecting whether to execute the machine learning model for second input data based on the error.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 depicts an example workflow for generating model output using selective machine learning model execution.

FIG. 2 depicts an example system for selective machine learning model execution.

FIG. 3 is a flow diagram depicting an example method for selective machine learning model execution.

FIG. 4 is a flow diagram depicting an example method for updating model simulator parameters for selective machine learning model execution.

FIG. 5 is a flow diagram depicting an example method for selective model execution.

FIG. 6 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for improved machine learning via selective model execution.

In some aspects, rather than executing machine learning models each time model output is desired, machine learning systems can selectively execute the model for only some inputs. In some aspects, for other inputs, the system can generate simulated output (also referred to in some aspects as simulator output, predicted output, estimated output, extrapolated output, and the like) using other approaches that are less computationally complex than generating output data using the machine learning model itself. For example, rather than use a machine learning model (e.g., a neural network) to generate output for each frame of video, the system may use less computationally expensive techniques, such as a regression operation or a less computationally complex machine learning model (or other non-machine learning based model), to generate estimated or simulator output for some of the frames (reserving execution of the more complex machine learning model for only a subset of frames). In this way, the computational expense of generating outputs for a set of inputs is substantially reduced.

Generally, a wide variety of machine learning or artificial intelligence tasks can be used to provide efficient output using aspects of the present disclosure. For example, the tasks may be include image processing to perform operations such as face detection, object segmentation, facial landmark prediction, scene depth estimation, and the like. Generally, although many machine learning models and architectures have been developed to achieve highly competitive performance in terms of prediction accuracy, executing these models remains computationally complex. Frequently, executing or running such models relies on substantial computing resources and results in significant power consumption, particularly in real-time settings (e.g., to perform face detection for frames in a live video feed or capture). Using aspects of the present disclosure to reduce these computations can enable not only substantially improved power efficiency, but further enable the use or execution of larger (and frequently more accurate) models.

Some conventional systems generally simply execute the machine learning model(s) whenever output is required or desired. For example, consider a face detection model that takes an image as input and outputs a set of bounding boxes for faces in the input image. In conventional systems, the model may be used to process the input at a relatively high frame rate (e.g., 30 frames per second). This leads to high power consumption and resource demands, as many machine learning models are computationally complex and expensive.

However, using aspects of the present disclosure, the system can sparsely execute the machine learning models selectively (e.g., for every other frame, or for every third frame), rather than for all inputs. In some aspects, the system can include an output predictor (e.g., a model simulator) that can generate an output even when the real output from the machine learning model is not available (e.g., because the model was purposefully not executed for the input).

In some aspects, the system can provide selective model execution based on the current and/or historical error of the simulated or estimated output. In some aspects, the system may compare the error against one or more thresholds, and may selectively use the machine learning model, as compared to using the less complex simulator, based on the comparison between the error and the threshold(s). Additionally or alternatively in some aspects, the system may determine how frequently to use the machine learning model, as compared to using the less complex simulator. That is, the system may determine how many times the output should be returned from the simulator before the machine learning model is executed again. For example, the system may execute the machine learning model for every other frame of input data (using the simulator for the remaining frames), for every fifth frame (using the simulator to generate output for the other four), and so on.

### Example Workflow for Generating Model Output Using Selective Machine Learning Model Execution

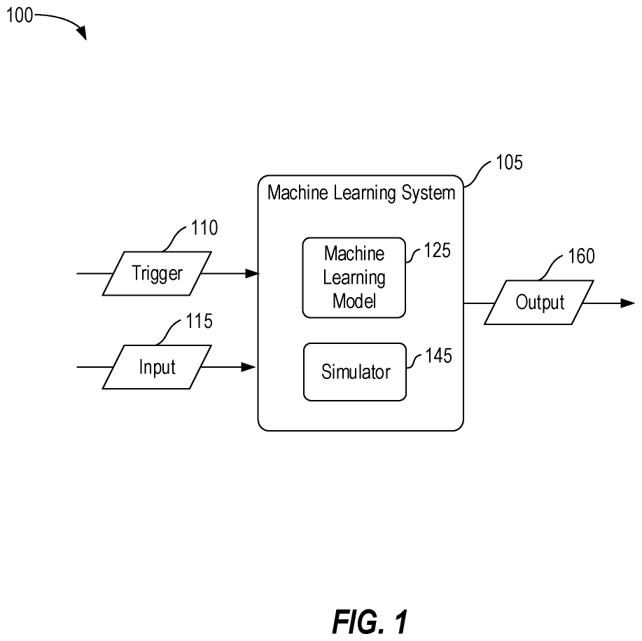

FIG. 1 depicts an example workflow 100 for generating model output using selective machine learning model execution.

In the illustrated example, a machine learning system 105 accesses a trigger 110 and input 115 to generate output 160. As used herein, accessing data can generally include receiving, requesting, retrieving, generating, measuring, sensing, or otherwise gaining or obtaining access to the data. Though illustrated as a discrete system for conceptual clarity, in some aspects, the functionality of the machine learning system 105 may be implemented as a standalone system or as a component of a broader system (e.g., on mobile device). In aspects, the operations of the machine learning system 105 may be implemented using hardware, software, or a combination of hardware and software.

In the illustrated workflow 100, the trigger 110 is used to indicate when output 160 should be generated. That is, when the trigger 110 is received, the machine learning system 105 may access and/or process the input 115 to generate the output 160. In some aspects, the trigger 110 corresponds to a request or instruction to generate output 160. For example, another component or system may provide the trigger 110 (e.g., via an application programming interface (API)) to cause the output 160 to be generated. Although depicted as discrete from the input 115, in some aspects, the input 115 itself acts as the trigger 110. That is, in some aspects, when the input 115 is provided or accessed by the machine learning system 105, the machine learning system 105 may interpret this new input 115 as a request or trigger 110 to generate output 160 automatically (without an explicit request).

As discussed above, the particular contents and structure of the trigger 110 and input 115 may vary depending on the particular implementation and task. For example, in a face detection task, the input 115 may include an image (e.g., a frame of a video), and the trigger 110 may generally correspond to a request to identify faces in the provided image.

In the illustrated example, the machine learning system 105 includes a machine learning model 125 and a simulator 145. The machine learning model 125 generally corresponds to a trained model that can generate output predictions based on input 115. Generally, the particular architecture and structure of the machine learning model 125 may vary depending on the particular implementation and task. For example, the machine learning model 125 may correspond to or include one or more neural networks, transformer-based architectures, and the like.

The simulator 145 generally corresponds to a model or estimator that can generate similar output to the machine learning model 125 while using fewer computational resources than the machine learning model 125. For example, the simulator 145 may use less memory, fewer compute cycles, less power, or any other reduced resource usage. In some aspects, the simulator 145 uses regression techniques, such as linear regression or curve fitting (also referred to as “nonlinear regression”).

In the workflow 100, the machine learning system 105 can selectively use the machine learning model 125, the simulator 145, or both to generate output 160. For example, as discussed above, the machine learning system 105 may use the machine learning model 125 to generate output for every fifth trigger 110, using the simulator 145 for the other four. That is, given a sequence of triggers or requests, the machine learning system 105 may use the machine learning model 125 for the first trigger, followed by N applications of the simulator 145 (where N may be a manually defined hyperparameter or a learned parameter), before executing the machine learning model 125 again for the (N+1)th trigger.

In some aspects, the output 160 of the machine learning system 105 corresponds to the output generated by either the machine learning model 125 or the simulator 145, depending on which was executed or used for the given trigger 110. That is, when the machine learning model 125 is executed to generate model output, the output 160 may correspond to this model output. When the simulator 145 is used to generate simulator output (and the machine learning model 125 is not used, reducing computational expense), the output 160 may correspond to this simulator output. In some aspects, the machine learning system 105 may output and/or use the simulator output regardless of whether the model output is available. In some aspects, by using the simulator 145 for all output, the output 160 may be smoother and/or less noisy, as compared to the model output, as discussed in more detail below.

In this way, the machine learning system 105 can provide selective execution of the machine learning model 125 while still providing output 160 for each trigger 110. This substantially reduces the computational expense of the machine learning system 105, allowing machine learning to be used in more constrained devices and/or to be used more often, more efficiently, and with reduced expense on any device.

### Example System for Selective Machine Learning Model Execution

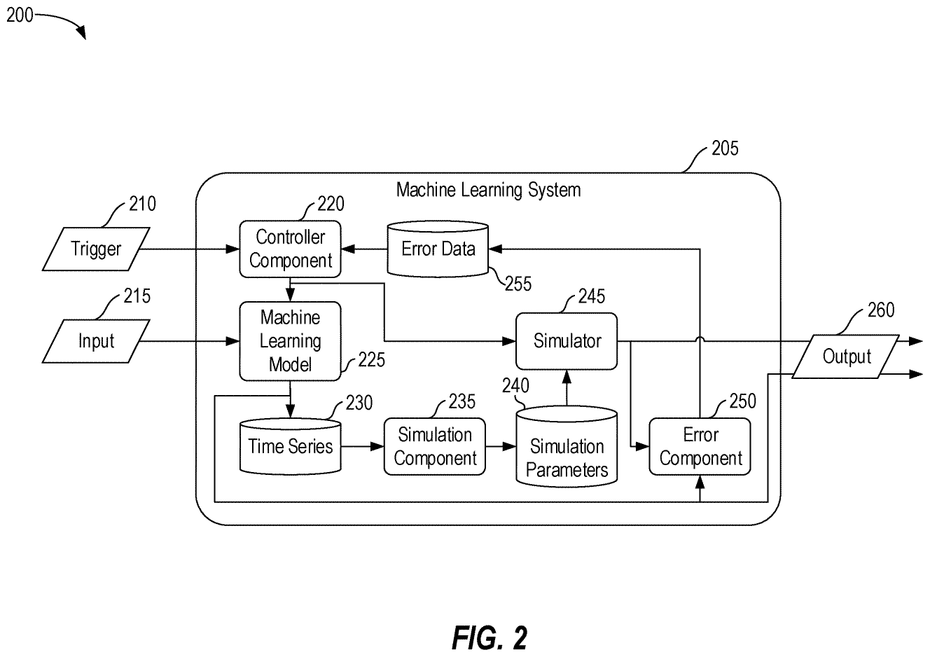

FIG. 2 depicts an example system 200 for selective machine learning model execution.

In the illustrated example, a machine learning system 205 accesses a trigger 210 and input 215 to generate output 260. Though illustrated as a discrete system for conceptual clarity, in some aspects, the functionality of the machine learning system 205 may be implemented as a standalone system or as a component of a broader system (e.g., on mobile device). In aspects, the operations of the machine learning system 205 may be implemented using hardware, software, or a combination of hardware and software. In some aspects, the machine learning system 205 corresponds to the machine learning system 105 of FIG. 1.

As illustrated, the machine learning system 205 includes a controller component 220, a machine learning model 225 (which may correspond to the machine learning model 125 of FIG. 1), a simulation component 235, a simulator 245 (which may correspond to the simulator 145 of FIG. 1), and an error component 250. Though illustrated as discrete components for conceptual clarity, in aspects, the operations of the depicted components may be combined or distributed across any number of components.

In the illustrated workflow, when the trigger 210 (which may correspond to the trigger 110 of FIG. 1) is received, the machine learning system 205 can access and/or process the input 215 (which may correspond to the input 115 of FIG. 1) to generate output 260 (which may correspond to the output 160 of FIG. 1). In some aspects, the trigger 210 corresponds to a request or instruction to generate output. For example, another component or system may provide the trigger 210 (e.g., via an API) to cause the output 260 to be generated. Although depicted as discrete from the input 215, as discussed above, the input 215 may itself act as the trigger 210 in some aspects. As discussed above, the particular contents and structure of the trigger 210 and input 215 may vary depending on the particular implementation and task.

In the illustrated example, when the trigger 210 and/or input 215 is provided, the controller component 220 can select or determine whether to execute the machine learning model 225 and/or the simulator 245 based at least in part on error data 255. In some aspects, the error data 255 generally indicates the current and/or historical error rate of the simulator 245. That is, the error data 255 may indicate the aggregate (e.g., average or median) difference or error between the output of the simulator 245 (e.g., simulator output) and the output of the machine learning model 225 (e.g., model output), as discussed in more detail below. For example, the error data 255 may indicate the mean-squared error or distance between the simulator output and the most recent model output, as discussed in more detail below.

In some aspects, the controller component 220 evaluates the error data 255 using one or more criteria, such as one or more thresholds, to determine whether to execute the machine learning model 225 to process the input 215. For example, in some aspects, the controller component 220 can determine whether the latest error data 255 is below a threshold. If not (e.g., if the error is high), then the controller component 220 may determine to execute the machine learning model 225 to process the input 215. If the error is low, then the controller component 220 may determine to use the simulator 245 to generate simulator output (which is generally more efficient or less computationally expensive than using the machine learning model 225).

In some aspects, the controller component 220 evaluates the error data 255 to determine how many sequential inputs or triggers can be processed using the simulator 245 before the machine learning model 225 is executed again. In some aspects, the controller component 220 may compare the error data 255 against one or more thresholds, determining the number of inputs that can bypass the machine learning model 225. For example, if the error is below a first threshold, then the controller component 220 may determine that the next N (e.g., the next three) triggers 210 can be responded to (e.g., the next N inputs 215 may be processed) using the simulator 245. If the error is above the first threshold but below a second threshold, then the controller component 220 may determine that the next M (e.g., the next two) triggers 210 can be responded to using the simulator 245. Once the determined number of inputs 215 or triggers 210 have been received, the controller component 220 can determine to execute the machine learning model 225 again for the next input.

For example, if the input 215 corresponds to a sequence of image frames from a video, then the controller component 220 may determine whether to execute the machine learning model 225 for every frame, every other frame, every third frame, every fifth frame, and so on. For the intervening frames, the simulator 245 may be used to generate the output 260. In some aspects, regardless of how low the error data 255 is, the controller component 220 may be configured to execute the machine learning model 225 with at least a threshold frequency (e.g., at least every fifth frame).

As illustrated, if the controller component 220 determines to use the simulator 245, then the simulator 245 can generate and provide the output 260 from the machine learning system 205. In some aspects, the simulator 245 does not actually process the input 215 to generate the simulator output. In some aspects, if the simulator 245 is a linear regression model or other regression curve (e.g., a line or curve that gives the simulator output for a given timestamp), then the controller component 220 may use the timestamp of the input 215 or trigger 210 to generate the simulator output without actually processing the input 215 itself. For example, if the output corresponds to the coordinates of a detected face in an input image, then the simulator 245 may be a regression curve (generated based on one or more prior model outputs, as discussed in more detail below) giving the coordinate(s) at each timestamp. This curve can then be used to extrapolate the coordinates to new timestamps in order to efficiently generate simulator output without actually processing the new images.

As illustrated, if the controller component 220 determines to execute the machine learning model 225 (e.g., because the error data 255 is high, or because the determined number of triggers 210 or inputs 215 have sequentially been processed using the simulator 245 without executing the machine learning model 225), then the controller component 220 causes the machine learning model 225 to generate model output based on the input 215. For example, as discussed above, the machine learning model 225 may be a neural network or other architecture trained to process input 215 using trained parameters (e.g., using convolution) to generate output predictions (e.g., face coordinates or bounding boxes).

In the illustrated example, this model output can optionally be used as the output 260 from the machine learning system 205. That is, in some aspects, the output of the machine learning model 225 may be provided as the output 260 whenever the controller component 220 determines to execute the machine learning model 225. In some aspects, even when the machine learning model 225 is executed, the controller component 220 may nevertheless also execute the simulator 245 and use the simulator output as the output 260 of the machine learning system 205. In some aspects, as the simulator output is generated based at least in part on one or more prior model outputs (e.g., the last ten model outputs), the simulator output may tend to be smoother and less noisy, as compared to the model output (which may not depend on the prior output). In some aspects, the simulator output is smoother and/or less noisy at least in part because the simulator output is generated using a simpler model (e.g., a linear model), which tends to filter out high-frequency content or variations. In this way, by using the simulator output for all triggers 210 regardless of whether the machine learning model 225 is executed, the machine learning system 205 may generate smoother and less noisy output 260, as compared to conventional solutions that use the model output for all input frames.

As depicted, each time model output is generated by the machine learning model 225, the model output is stored or buffered in a repository for a time series 230 of model outputs. In aspects, the time series 230 may be implemented using any suitable technique or structure, such as a cache, a storage, a memory, a buffer, and the like. Generally, the time series 230 can store the generated model output for some number of prior inputs 215, such as the last five, the last ten, and so on. In some aspects, in addition to storing the generated model output, the time series 230 can also include a label or indication of the corresponding timestamp of the input used to generate the corresponding output. For example, as discussed above, the time series 230 may indicate, for each respective model output of the last X model outputs (e.g., the last ten outputs generated for the last ten executions of the machine learning model 225), a respective timestamp of the corresponding input 215.

In the illustrated example, each time a new model output is added to the time series 230, the simulation component 235 can evaluate the time series 230 to generate updated simulation parameters 240. For example, as discussed above, the simulation component 235 may use linear regression (or more complex regression analysis using one or more curves) to fit one or more lines (or curves) to the time series 230. That is, the simulation component 235 may learn or determine a set of simulation parameters 240 (e.g., curve or line parameters) that fit the time series 230. In this way, the simulation parameters 240 can be used to instantiate or create a simulator 245 and the simulator output can be generated for a given timestamp by finding the corresponding point on the line or curve.

Although some examples of the present disclosure discuss using regression (e.g., linear regression) for the simulator 245, in some aspects, other models or techniques can be used. For example, the simulation component 235 may train a small or lightweight neural network using the time series 230. Generally, the simulator 245 may correspond to any model or architecture that is less computationally complex or expensive than the machine learning model 225. For example, as discussed above, executing the simulator 245 may consume less power, less compute, less memory, and/or less storage, exhibit less latency, and the like.

As illustrated, when the machine learning model 225 is executed, the generated model output is further provided to the error component 250. Further, as illustrated, the updated simulator 245 (using updated simulation parameters 240 generated based on the updated time series 230 including the new model output), can be additionally used to generate simulator output for the same input 215 and/or trigger 210, which is also provided to the error component 250. In this way, the error component 250 can determine the error or accuracy of the updated simulator 245, based on the current model output (e.g., based on the current input 215).

The error component 250 can generally determine the error using any suitable criteria or techniques. For example, in some aspects, the error component 250 determines the mean-squared error or distance between the simulator output and the model output. As illustrated, this updated error information is stored or maintained in the error data 255. In some aspects, the error data 255 includes the latest error (e.g., the current error of the current version of the simulator 245, with respect to the most-recent model output). In some aspects, the error data 255 can additionally or alternatively include aggregate error, such as the average or median error over the last few inputs and/or the last few version of the simulator 245.

In this way, for the next one or more inputs 215 or triggers 210, the controller component 220 can evaluate the updated error data 255 to determine whether to bypass the machine learning model 225 (e.g., refrain from executing the machine learning model 225) for the input 215 or trigger 210, and/or determine how many sequential triggers or requests can bypass the machine learning model 225. That is, the controller component 220 can determine whether to execute the machine learning model 225 for the next input 215, and/or how many inputs 215/triggers 210 should be received and processed before the machine learning model 225 is executed again.

### Example Method for Selective Machine Learning Model Execution

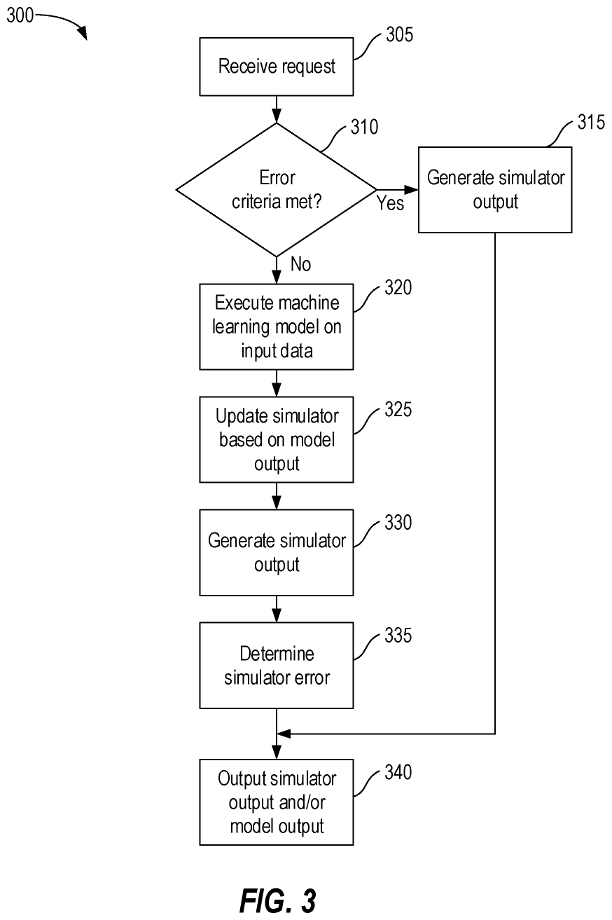

FIG. 3 is a flow diagram depicting an example method 300 for selective machine learning model execution. In some aspects, the method 300 is performed by a machine learning system, such as the machine learning system 105 of FIG. 1 and/or the machine learning system 205 of FIG. 2.

At block 305, the machine learning system receives or accesses a request to generate output based on some input data. For example, as discussed above, the machine learning system may receive input data such as input 115 of FIG. 1 and/or input 215 of FIG. 2. In some aspects, the request includes or is accompanied with an explicit request, instruction, or trigger, such as trigger 110 of FIG. 1 and/or trigger 210 of FIG. 2. In some aspects, as discussed above, the input data itself acts as the trigger/request. That is, the machine learning system may be configured to process input when received or accessed, rather than waiting for any explicit trigger or instruction.

As discussed above, the request may generally be received or accessed from any system, component, or entity, including another component of the machine learning system, a remote system, a user, and the like. In some aspects, the machine learning system operates as a component or module of a broader system (e.g., a smartphone) and the request is received from another component or module of the system (e.g., a camera application).

At block 310, the machine learning system determines whether one or more error criteria are met. For example, as discussed above, the machine learning system may determine and/or evaluate the current and/or historical error of a model simulator (e.g., simulator 245 of FIG. 2). In some aspects, as discussed above, the simulator error may be determined each time new model output is available (e.g., each time the machine learning model is executed). For example, the machine learning system may use the new model output (along with one or more prior outputs) to refine or update the simulator (or to generate a new simulator), and use the updated simulator to generate new simulator output. This new simulator output can then be compared against the new model output to determine the updated simulator error.

In some aspects, as discussed above, determining whether the error criteria is met comprises comparing the error against one or more thresholds. For example, if the error is above a threshold, then the machine learning system may determine to use the machine learning model to process the input data. If the error is below a threshold, then the machine learning system may determine to bypass the machine learning model and generate output using the simulator. In some aspects, the criteria indicate a number of sequential inputs to bypass the machine learning model. For example, as discussed above, the machine learning system may determine whether to bypass the model for one input, two inputs in a row, three inputs in a row, and the like.

If, at block 310, the machine learning system determines that the criteria are met (e.g., the error is sufficiently low, or a currently or previously determined number of times to bypass the machine learning model has not been met), the method 300 continues to block 315. At block 315, the machine learning system generates simulator output using a model simulator. For example, as discussed above, the model simulator may implement or use regression analysis (e.g., linear regression) based on previous model output to predict, extrapolate, estimate, or simulate output for the current request. In some aspects, as discussed above, the model simulator may generate the simulator output based on a timestamp of the request, without actually processing the input data itself. The method 300 then continues to block 340, where the machine learning system outputs the simulator output as response to the request. For example, the machine learning system may return, transmit, or otherwise provide the simulator output to the requesting entity or component (or to another system or component) as a resulting output based on the input data (even if the input data was not itself processed by the simulator).

Returning to block 310, if the machine learning system determines that the error criteria are not met (e.g., the error is sufficiently high, or a currently or previously determined number of times to bypass the machine learning model has been met), then the method 300 continues to block 320. At block 320, the machine learning system executes the machine learning model on the input data indicated or included in the request.

For example, as discussed above, the machine learning system may process the input data using the model to generate a model output. In some aspects, the machine learning system may optionally perform preprocessing on the input prior to executing the model, depending on the particular implementation and architecture.

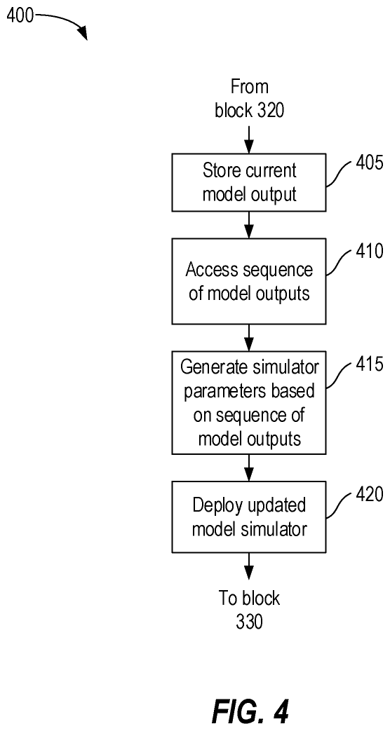

At block 325, the machine learning system updates the model simulator based on the model output (generated at block 320). For example, as discussed above, the machine learning system may use the current model output along with one or more prior model outputs to update the simulator parameters (e.g., curve parameters). Generally, updating the simulator model may include refining or fine-tuning the parameters of the simulator and/or generating a new simulator entirely based on the model output. One example method to update the model simulator is discussed below in more detail with reference to FIG. 4.

At block 330, the machine learning system can then generate simulator output using the updated model simulator. For example, as discussed above, the model simulator may implement or use regression analysis (e.g., linear regression) based on previous model output to predict, extrapolate, estimate, or simulate output for the current request. In some aspects, as discussed above, the model simulator may generate the simulator output based on a timestamp of the request, without actually processing the input data itself.

At block 335, the machine learning system determines the simulator error based on the current simulator output (generated at block 330) and the current model output (generated at block 320). For example, as discussed above, the machine learning system may compute the mean-squared error or distance between the simulator output and model output. In some aspects, at block 335, the machine learning system may additionally or alternatively determine an aggregate error, such as by aggregating the current error with the previously determined error metric (e.g., averaging the current error with the prior error from the prior simulation).

In some aspects, at block 335, the machine learning system may determine the error of the current simulator by using the updated model simulator to generate a set of simulator outputs, one for each available prior model output (e.g., stored in the time series 230 of FIG. 2 and/or used to train or update the simulator). This can allow the machine learning system to determine the average or aggregate error of the updated simulator with respect to a number of samples (e.g., the last ten samples), rather than only the current sample.

At block 340, the machine learning system can output the simulator output (generated at block 330) and/or the model output (generated at block 320). For example, as discussed above, the machine learning system may return, transmit, or otherwise provide the simulator output and/or the model output to the requesting entity or component as a resulting output based on the input data. In some aspects, as discussed above, providing the simulator output for all requests may result in a smoother or less noisy set of predictions, as compared to providing the machine learning model output directly.

### Example Method for Updating Model Simulator Parameters for Selective Machine Learning Model Execution

FIG. 4 is a flow diagram depicting an example method 400 for updating model simulator parameters for selective machine learning model execution. In some aspects, the method 400 is performed by a machine learning system, such as the machine learning system 105 of FIG. 1 and/or the machine learning system 205 of FIG. 2. In some aspects, the method 400 provides additional detail for block 325 of FIG. 3.

At block 405, the machine learning system stores or otherwise maintains the current model output. For example, as discussed above, the machine learning system may store the model output in a cache, buffer, memory, or other storage repository that includes one or more prior model outputs (e.g., in time series 230 of FIG. 2). In some aspects, in addition to the model output itself, the machine learning system stores the corresponding input data (or a pointer thereto), and/or a timestamp associated with the input/request. Generally, the specific data stored with the model output may vary depending on the particular implementation and architecture of the model simulator. For example, if the model simulator implements regression analysis, then the machine learning system may store the model output and corresponding input timestamps. If the model simulator uses a lightweight neural network or other model, then the machine learning system may store the input itself as well.

At block 410, the machine learning system accesses a sequence of model outputs (e.g., the last ten outputs generated by executing the machine learning model). Generally, the number of outputs in the sequence may vary depending on the particular implementation. At block 415, the machine learning system then generates or updates one or more simulator parameters based on the accessed sequence of model outputs. For example, as discussed above, the machine learning system may use regression to fit a line or curve to the sequence of outputs, may train a lightweight neural network using the sequence of outputs, and the like.

At block 420, the machine learning system then deploys the updated model simulator. Generally, deploying the updated simulator can include any operations to provide or use the updated simulator to generate simulator output, such as storing the simulator parameters in one or more repositories, instantiating a model based on the parameters, and the like.

### Example Method for Selective Model Execution

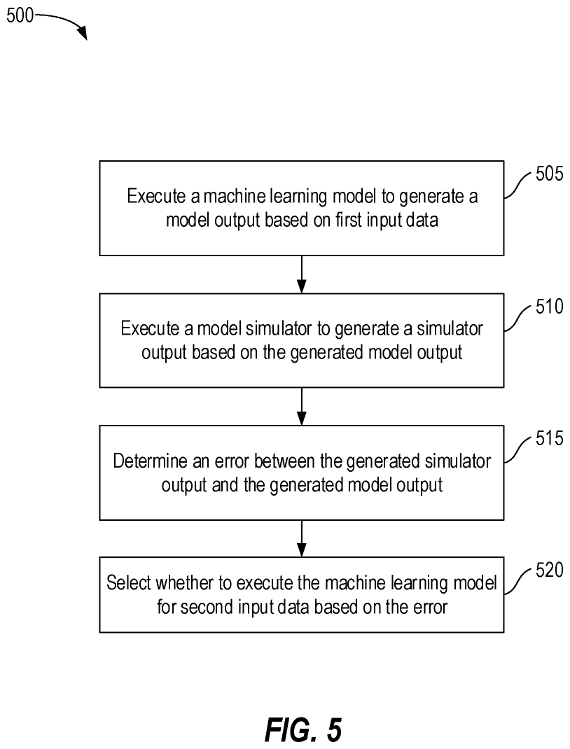

FIG. 5 is a flow diagram depicting an example method 500 for selective model execution. In some aspects, the method 500 is performed by a machine learning system, such as the machine learning system 105 of FIG. 1 and/or the machine learning system 205 of FIG. 2.

At block 505, a machine learning model is executed to generate a model output based on first input data.

At block 510, a model simulator is executed to generate a simulator output based on the generated model output.

In some aspects, the model simulator implements a regression analysis on the generated model output.

In some aspects, the regression analysis comprises linear regression.

In some aspects, the simulator output is generated based on a timestamp of the first input data, and the first input data is not processed by the model simulator.

At block 515, an error between the generated simulator output and the generated model output is determined.

At block 520, whether to execute the machine learning model for second input data is selected based on the error.

In some aspects, selecting whether to execute the machine learning model for the second input data comprises, in response to determining that the error satisfies one or more criteria, determining to execute the machine learning model to generate second model output for the second input data.

In some aspects, selecting whether to execute the machine learning model for the second input data comprises, in response to determining that the error satisfies one or more criteria: refraining from processing the second input data using the machine learning model, generating second simulator output using the model simulator for the second input data, and outputting the second simulator output.

In some aspects, selecting whether to execute the machine learning model for the second input data comprises determining, based on comparing the error to one or more thresholds, how many sequential requests to bypass the machine learning model.

In some aspects, the method 500 further includes storing the model output as time series data and generating updated parameters for the model simulator based on the time series data.

In some aspects, the method 500 further includes outputting the model output.

In some aspects, the method 500 further includes outputting the simulator output.

### Example Processing System for Selective Machine Learning Model Execution

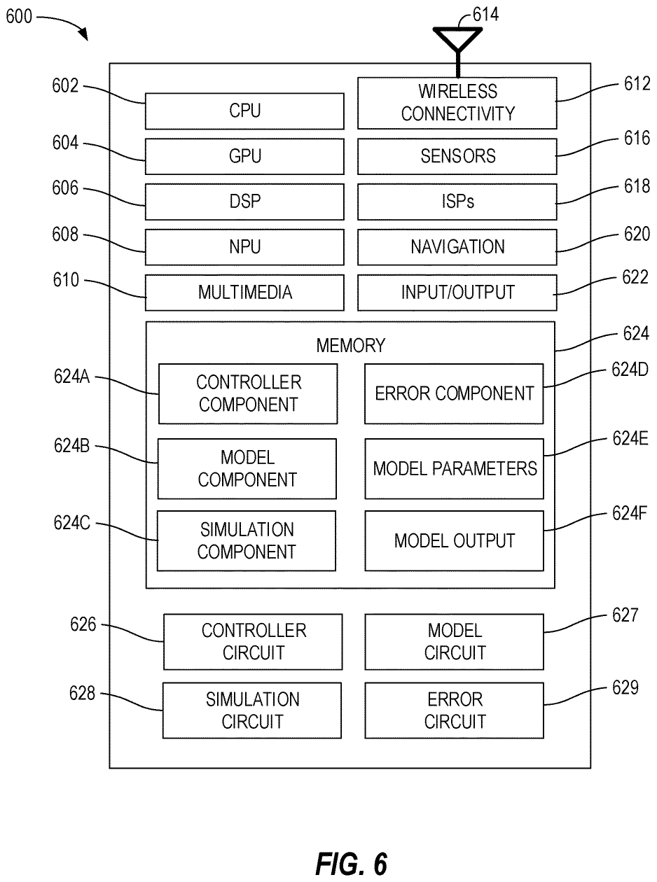

In some aspects, the workflows, techniques, and methods described with reference to FIGS. 1-5 may be implemented on one or more devices or systems. FIG. 6 depicts an example processing system 600 configured to perform various aspects of the present disclosure, including, for example, the techniques and methods described with respect to FIGS. 1-5. In some aspects, the processing system 600 may train, implement, use, or provide a prediction architecture using one or more machine learning models and one or more model simulators. In some aspects, the processing system 600 corresponds to the machine learning system 105 of FIG. 1 and/or the machine learning system 205 of FIG. 2. Although depicted as a single system for conceptual clarity, in at least some aspects, as discussed above, the operations described below with respect to the processing system 600 may be distributed across any number of devices.

Processing system 600 includes a central processing unit (CPU) 602, which in some examples may be a multi-core CPU. Instructions executed at the CPU 602 may be loaded, for example, from a program memory associated with the CPU 602 or may be loaded from a partition of memory 624.

Processing system 600 also includes additional processing components tailored to specific functions, such as a graphics processing unit (GPU) 604, a digital signal processor (DSP) 606, a neural processing unit (NPU) 608, a multimedia processing unit 610, and a wireless connectivity component 612.

An NPU, such as NPU 608, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPUs), neural network processor (NNP), intelligence processing unit (IPU), vision processing unit (VPU), or graph processing unit.

NPUs, such as NPU 608, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new data through an already trained model to generate a model output (e.g., an inference).

In some implementations, NPU 608 is a part of one or more of CPU 602, GPU 604, and/or DSP 606.

In some examples, wireless connectivity component 612 may include subcomponents, for example, for third generation (3G) connectivity, fourth generation (4G) connectivity (e.g., Long-Term Evolution (LTE)), fifth generation connectivity (e.g., New Radio (NR)), Wi-Fi connectivity, Bluetooth connectivity, and other wireless data transmission standards. Wireless connectivity component 612 is further coupled to one or more antennas 614.

Processing system 600 may also include one or more sensor processing units 616 associated with any manner of sensor, one or more image signal processors (ISPs) 618 associated with any manner of image sensor, and/or a navigation component 620, which may include satellite-based positioning system components (e.g., GPS or GLONASS) as well as inertial positioning system components.

Processing system 600 may also include one or more input and/or output devices 622, such as screens, touch-sensitive surfaces (including touch-sensitive displays), physical buttons, speakers, microphones, and the like.

In some examples, one or more of the processors of processing system 600 may be based on an ARM or RISC-V instruction set.

Processing system 600 also includes memory 624, which is representative of one or more static and/or dynamic memories, such as a dynamic random access memory, a flash-based static memory, and the like. In this example, memory 624 includes computer-executable components, which may be executed by one or more of the aforementioned processors of processing system 600.

In particular, in this example, memory 624 includes a controller component 624A, a model component 624B, a simulation component 624C, and an error component 624D. Though depicted as discrete components for conceptual clarity in FIG. 6, the illustrated components (and others not depicted) may be collectively or individually implemented in various aspects.

In the illustrated example, the memory 624 further includes model parameters 624E and model output 624F. The model parameters 624E may generally correspond to the generated, learnable, and/or trainable parameters of one or more machine learning models and/or model simulators, such as the machine learning model 125 of FIG. 1, the machine learning model 225 of FIG. 2, the simulator 145 of FIG. 1, the simulator parameters 240 of FIG. 2, and/or the simulator 245 of FIG. 2. The model output 624F may generally comprise the generated output from one or more machine learning models (such as the machine learning model 125 of FIG. 1 and/or the machine learning model 225 of FIG. 2). For example, the model output 624F may correspond to the time series 230 of FIG. 2. In some aspects, the model output 624F further comprises the corresponding input and/or timestamp for each stored output.

Though depicted as residing in memory 624 for conceptual clarity, in some aspects, some or all of the model parameters 624E and model output 624F may reside in any other suitable location.

Processing system 600 further comprises controller circuit 626, model circuit 627, simulation circuit 628, and error circuit 629. The depicted circuits, and others not depicted, may be configured to perform various aspects of the techniques described herein.

In some aspects, controller component 624A and/or controller circuit 626 may be used to evaluate simulator errors to determine whether or how often to execute machine learning models, as discussed above. For example, the controller component 624A and/or controller circuit 626 may correspond to the controller component 220 of FIG. 2.

Model component 624B and/or model circuit 627 may be used to generate model output using one or more machine learning models, as discussed above. For example, the model component 624B and/or model circuit 627 may selectively execute machine learning model 125 of FIG. 1 and/or machine learning model 225 of FIG. 2 to process input (e.g., as instructed or controlled by the controller component 624A and/or controller circuit 626).

Simulation component 624C and/or simulation circuit 628 may be used to generate simulator output using one or more model simulators, as discussed above. For example, the simulation component 624C and/or simulation circuit 628 may use the simulator 145 of FIG. 1 and/or simulator 245 of FIG. 2 to generate simulator output (e.g., based on a provided or indicated timestamp of input data). In some aspects, the simulation component 624C and/or simulation circuit 628 may be used to generate simulator parameters (such as simulation parameters 240) based on prior model outputs (e.g., model output 624F), as discussed above. For example, the simulation component 624C and/or simulation circuit 628 may correspond to the simulation component 235 of FIG. 2.

Error component 624D and/or error circuit 629 may be used to determine or evaluate simulator errors based on simulator output (generated by a simulator, such as by simulation component 624C and/or simulation circuit 628) and model output (generated by a machine learning model, such as by model component 624B and/or model circuit 627), as discussed above. For example, the error component 624D and/or error circuit 629 may correspond to the error component 250 of FIG. 2. The controller component 624A and/or controller circuit 626 may use these computed error metrics to determine how often to execute the machine learning model.

Though depicted as separate components and circuits for clarity in FIG. 6, controller circuit 626, model circuit 627, simulation circuit 628, and error circuit 629 may collectively or individually be implemented in other processing devices of processing system 600, such as within CPU 602, GPU 604, DSP 606, NPU 608, and the like.

Generally, processing system 600 and/or components thereof may be configured to perform the methods described herein.

Notably, in other aspects, aspects of processing system 600 may be omitted, such as where processing system 600 is a server computer or the like. For example, multimedia processing unit 610, wireless connectivity component 612, sensor processing units 616, ISPs 618, and/or navigation component 620 may be omitted in other aspects. Further, aspects of processing system 600 maybe distributed between multiple devices.

### Example Clauses

Implementation examples are described in the following numbered clauses:

Clause 1: A method, comprising: executing a machine learning model to generate a model output based on first input data; executing a model simulator to generate a simulator output based on the generated model output; determining an error between the generated simulator output and the generated model output; and selecting whether to execute the machine learning model for second input data based on the error.

Clause 2: A method according to Clause 1, wherein the model simulator implements a regression analysis on the generated model output.

Clause 3: A method according to Clause 2, wherein the regression analysis comprises linear regression.

Clause 4: A method according to any of Clauses 1-3, wherein selecting whether to execute the machine learning model for the second input data comprises, in response to determining that the error satisfies one or more criteria, determining to execute the machine learning model to generate second model output for the second input data.

Clause 5: A method according to any of Clauses 1-4, further comprising: storing the model output as time series data; and generating updated parameters for the model simulator based on the time series data.

Clause 6: A method according to any of Clauses 1-5, further comprising outputting the model output.

Clause 7: A method according to any of Clauses 1-6, wherein: the simulator output is generated based on a timestamp of the first input data, and the first input data is not processed by the model simulator.

Clause 8: A method according to any of Clauses 1-7, further comprising outputting the simulator output.

Clause 9: A method according to any of Clauses 1-8, wherein selecting whether to execute the machine learning model for the second input data comprises, in response to determining that the error satisfies one or more criteria: refraining from processing the second input data using the machine learning model; generating second simulator output using the model simulator for the second input data; and outputting the second simulator output.

Clause 10: A method according to any of Clauses 1-9, wherein selecting whether to execute the machine learning model for the second input data comprises determining, based on comparing the error to one or more thresholds, how many sequential requests to bypass the machine learning model.

Clause 11: A processing system comprising: a memory comprising computer-executable instructions; and one or more processors configured to execute the computer-executable instructions and cause the processing system to perform a method in accordance with any of Clauses 1-10.

Clause 12: A processing system comprising means for performing a method in accordance with any of Clauses 1-10.

Clause 13: A non-transitory computer-readable medium comprising computer-executable instructions that, when executed by one or more processors of a processing system, cause the processing system to perform a method in accordance with any of Clauses 1-10.

Clause 14: A computer program product embodied on a computer-readable storage medium comprising code for performing a method in accordance with any of Clauses 1-10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A computer-implemented method, comprising:
executing a machine learning model to generate a model output based on first input data;
executing a model simulator to generate a simulator output based on the generated model output;
determining an error between the generated simulator output and the generated model output; and
selecting whether to execute the machine learning model for second input data based on the error.

2. The computer-implemented method of claim 1, wherein the model simulator implements a regression analysis on the generated model output.

3. The computer-implemented method of claim 2, wherein the regression analysis comprises linear regression.

4. The computer-implemented method of claim 1, wherein selecting whether to execute the machine learning model for the second input data comprises, in response to determining that the error satisfies one or more criteria, determining to execute the machine learning model to generate second model output for the second input data.

5. The computer-implemented method of claim 1, further comprising:
storing the model output as time series data; and
generating updated parameters for the model simulator based on the time series data.

6. The computer-implemented method of claim 1, further comprising outputting the model output.

7. The computer-implemented method of claim 1, wherein:
the simulator output is generated based on a timestamp of the first input data, and
the first input data is not processed by the model simulator.

8. The computer-implemented method of claim 1, further comprising outputting the simulator output.

9. The computer-implemented method of claim 1, wherein selecting whether to execute the machine learning model for the second input data comprises, in response to determining that the error satisfies one or more criteria:
refraining from processing the second input data using the machine learning model;
generating second simulator output using the model simulator for the second input data; and
outputting the second simulator output.

10. The computer-implemented method of claim 1, wherein selecting whether to execute the machine learning model for the second input data comprises determining, based on comparing the error to one or more thresholds, how many sequential requests to bypass the machine learning model.

11. A processing system comprising:
a memory comprising computer-executable instructions; and one or more processors configured to execute the computer-executable instructions and cause the processing system to perform an operation comprising:
executing a machine learning model to generate a model output based on first input data;
executing a model simulator to generate a simulator output based on the generated model output;
determining an error between the generated simulator output and the generated model output; and
selecting whether to execute the machine learning model for second input data based on the error.

12. The processing system of claim 11, wherein the model simulator implements a regression analysis on the generated model output.

13. The processing system of claim 12, wherein the regression analysis comprises nonlinear regression.

14. The processing system of claim 11, wherein selecting whether to execute the machine learning model for the second input data comprises, in response to determining that the error satisfies one or more criteria, determining to execute the machine learning model to generate second model output for the second input data.

15. The processing system of claim 11, the operation further comprising:
storing the model output as time series data; and
generating updated parameters for the model simulator based on the time series data.

16. The processing system of claim 11, the operation further comprising outputting the model output.

17. The processing system of claim 11, wherein:
the simulator output is generated based on a timestamp of the first input data, and
the first input data is not processed by the model simulator.

18. The processing system of claim 11, the operation further comprising outputting the simulator output.

19. The processing system of claim 11, wherein selecting whether to execute the machine learning model for the second input data comprises, in response to determining that the error satisfies one or more criteria:
refraining from processing the second input data using the machine learning model;
generating second simulator output using the model simulator for the second input data; and
outputting the second simulator output.

20. The processing system of claim 11, wherein selecting whether to execute the machine learning model for the second input data comprises determining, based on comparing the error to one or more thresholds, how many sequential requests to bypass the machine learning model.

21. (canceled)

22. (canceled)

23. (canceled)

24. (canceled)

25. (canceled)

26. (canceled)

27. (canceled)

28. (canceled)

29. (canceled)

30. (canceled)
